(19) United States
(12) Patent Application Publication
(10) Pub. No.: US 2013/0014267 A1
(43) Pub. Date: Jan. 10, 2013

(54) COMPUTER PROTOCOL GENERATION AND OBFUSCATION

(76) Inventors: Augustin J. FARRUGIA, Cupertino, CA (US); Mathieu CIET, Paris (FR); Pierre BETOUIN, Paris (FR)

(21) Appl. No.: 13/178,383

(22) Filed: Jul. 7, 2011

(51) Int. Cl. G06F 21/00

(52) U.S. Cl. 726/26

(57) ABSTRACT

In the field of computer science, communications protocols (such as computer network protocols) are hardened (secured) against reverse engineering attacks by hackers using a software tool which is applied to a high level definition of the protocol. The tool converts the definition to executable form, such as computer source code, and also applies reverse-engineering countermeasures to the protocol definition as now expressed in source code, to prevent hackers from recovering useful details of the protocol. This conversion process also allows preservation of backwards version compatibility of the protocol definition.

### FIELD OF THE INVENTION

This invention relates to computer science and to communications protocols used between computing devices.

### BACKGROUND

Content protection is computer software used to implement various protection means to keep digital content (music, video, applications, etc.) secure. This includes many aspects, including hardening computer code against reverse engineering. Content protection typically involves communications between computer-based entities (such as clients and servers) and often involves communications protocols.

A communications protocol is for instance a formal description of digital message formats and rules for exchanging those messages in or between computing systems and in telecommunications. More generally, a protocol defines exchanges between two entities. Protocols include signaling, authentication, error detection and correction capabilities, etc. A protocol describes syntax, semantics, and synchronization of communications and may be implemented in hardware or software, or both. An example is the Internet Protocol (IP) which defines data packets using the Internet Protocol suite. So a protocol is a description of a set of procedures to be followed when communicating.

The communications protocols in use on the Internet function in diverse settings. To ease design, communications protocols are structured using layering. Instead of a single universal protocol to handle all transmission tasks, a set of cooperating protocols for the layering is used. The layering for the Internet is called TCP/IP. The protocols are collectively called the Internet protocol suite. The number of layers and the way the layers are defined have an impact on the protocols. Communications protocols are agreed upon by the parties involved. To reach agreement a protocol is typically developed into an industry technical standard.

Attackers (hackers) are very interested in protocols since protocols are often the first stage of their attacks. One goal of hackers is to re-implement a standalone client (in terms of a client-server computer architecture) on top of a developed protocol. Reverse engineering a protocol by hackers is done in various ways, some of which are:

Differential analysis: This method recodes passively the protocol traffic, and sends some known values in order to analyze the impact of the protocol (changes in the field values, field shifts, etc). Some weak protocols can be fully reverse-engineered that way.

Reverse engineering a binary: When a protocol is obfuscated or encrypted (for security reasons), the attacker must find the binary application implementing this protocol. This way, all the protocols can be rebuilt by the attacker by analyzing the code handling it. This approach is time consuming and technically difficult.

Fault attacks: some attacks consist of injecting random (or semi random) values into an existing protocol and analyzing the returned values. One of the benefits of this approach is to evaluate boundaries of the protocol data fields. For instance, an attacker can guess that values for a given field should land in a range of 0 to 0x10 (decimal 16).

### SUMMARY

A goal of the present method is to provide a way (embodied here in a tool) to quickly design and code secure (obfuscated) communications protocols, based on an abstracted definition of the required data fields of the protocol and other information. Once built, such protocols are backwards compatible with previous versions, extensible, and their security level can be adjusted. Other security features can be implemented on top of these protocols, such as packet integrity, field shuffling inside a protocol packet, or a “timebomb” (a given time validity).

The present method provides countermeasures to prevent an attacker from easily retrieving protocol details, and allows software developers using the method to quickly develop strong and robust protocols, while accommodating software product needs (e.g., backward compatibility, legacy, etc.). This both hardens the product security and improves engineering ease of development.

### BRIEF DESCRIPTION OF THE FIGURES

FIG. 1 shows a flowchart of the present method.

FIGS. 2 and 3 show a computer system for implementing this method.

### DETAILED DESCRIPTION

Communications is typically the first step of any computer software development. The developer elaborates a kind of “language” to share information between computer based entities before being able to add features on top of computer software products. Many well known protocols (as described above) are defined and normalized, especially in the computer networking field (e.g., Internet, Ethernet, etc). Such protocols are required in many communications situations such as:

Between computers and other computing devices on a network;

Between computers and servers;

Between different computer software applications (processes) for a given operating system;

When storing or reading data files.

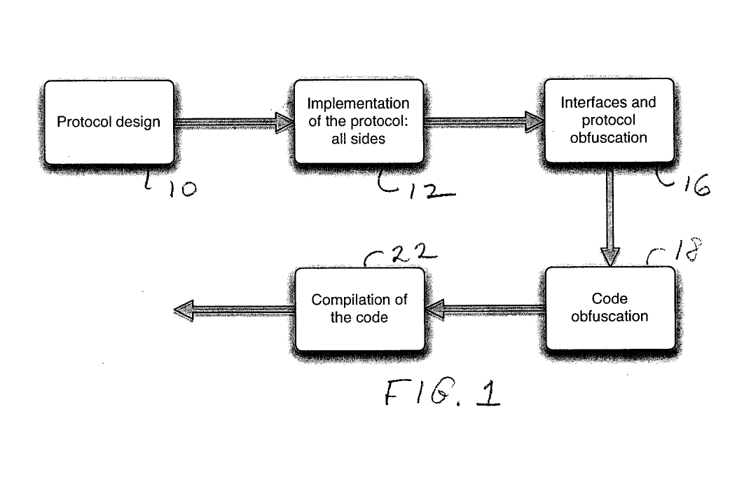

The present method describes creation and obfuscation of a protocol, with its data fields, its security options, its current version and other needed data in the form of a source code computer file which implements the protocol. FIG. 1 shows the present method in a flowchart. The protocol is conventionally designed at step 10. It is then conventionally implemented as a high level definition (as shown below) for all sides (the transmitting and receiving entities such as a client and a server) at step 12. Then in accordance with the invention, interfaces (the layer which represents the protocol communication) are provided and the definition at step 16 is converted into an executable computer source code file (in a predetermined computer programming language) as shown below. Then the protocol source code resulting from step 16 may be subject to code obfuscation at step 18.

This obfuscation includes, e.g., obfuscating the incoming data packets in terms of parsing, and obfuscating the outgoing data packets in terms of their construction. This obfuscates the protocol as expressed in the source code form, in terms of how a data packet is encapsulated or decapsulated. Steps 16 and 18 are performed by a software tool provided in accordance with the invention. Then this obfuscated source code is conventionally compiled by a compiler for that computer language into object (binary or machine) code at step 22 for conventional use.

In more detail, at step 16, the conventional (and non-executable) protocol definition file from step 12 is pre-processed by a software tool as described below before being compiled at step 22 (so the tool thereby operates pre-compilation). The tool (which is itself a computer program) converts the protocol description of step 12 into computer code in a suitable computer programming language. The tool includes:
A data structure definition which is available in the protocol source code for the developer to be able to access the data fields of the data structure directly;
A mangler or serializer which “flattens” all of the protocol data structure into a data structure suitable for storage in a memory (buffer), in order to be sent to a destination entity;
A parser which takes as input the flattened data structure, and extracts all of its values to be sent to a destination data structure in memory.

This method uses the following items (each having its own data field in the protocol definition) to define the protocol:

Protocol name, with a priori no restrictions. There may be a list of names to be excluded if previously used, or a list of permissible names.

Protocol seed: a binary character string (of fixed length), which is the main identifier of each protocol. A seed is used to avoid collision (confusion) between two protocols, and is derived from a deterministic, collision-free function in order to compute various security options (such as an encryption key, scrambling parameters, etc.). Any protocol generated with a given seed and having a given version number (see below) has the same structure and the same properties. This ensures backward (version) compatibility and deterministic behavior. This means that several source code compilations (with the same compiler) result in the same binary (object code) representation of a protocol.

Current protocol version: this is the protocol version number to implement. The data pair (protocol_seed, protocol_version) provides various values which are used to reproduce a protocol having particular structure and properties. Version changes preferably ensure backward compatibility. For instance, a particular named protocol Version 1.0 should be compatible with Version 1.6 of that protocol. Different versions of a particular protocol need not be fully compatible, and compatible versions can be indicated in the definition of the protocol. For example, Versions 1.0 and 1.2 are defined as compatible, while Versions 1.4 and 2.1 are defined as not compatible.

Protocol data fields: All data fields and their associated types. The fields can be described recursively, which allows one to define a complex or non-flat (e.g., tree-like) data structure for the protocol. To ensure backwards compatibility, new fields preferably are appended to the end of the data structure of a prior version of that protocol, and not inserted between two existing data fields.

A set of data security options, which are optional. The software developer is free to select the security options to harden the security of the protocol. These options are (non-exhaustively): scrambling, encrypting, time bombing, checksumming, protocol integrity, inserting fake fields, variable length for fooling attackers, and field re-organization: moving fields in the packets to diversify their locations, etc. One of the strengths of these options is to hide from an attacker the same version of a protocol which is present in two different implementations. For instance, even if an attacker manages to reverse-engineer a protocol for a given software product, he will have to make the same reverse-engineering effort to break the next or updated protocol version, since recognizing the previous protocol is not possible for him, given the present method.

The following is an example of a conventional high level protocol definition resulting from step 12 and for each field it shows the field number, type (UInt) and length in bits (8, 16 or 32). It is conventionally shown as a source code comment since by itself it is not executable.

/* PROTOCOL_DEFINITION [PROT_NAME] [PROT_SEED]
[CURRENT_VERSION] [SEC_OPTIONS]

| | |
|---|---|
| * | |
| * Field1: | UInt32 |
| * Field2: | UInt24 |
| * Field3: | UInt32 |
| * Field4: | UInt16 |
| * Field5: | SUBFIELD |
| | Field51: UInt32 |
| | Field52: UInt26 |
| | Field53: UInt32 |
| * Field6: | UInt32 |

The equivalent obfuscated and executable C language (source code) protocol for the developer, created by the tool at step 16 of FIG. 1 could be:

struct Field5_SUBFIELD {

| | |
|---|---|
| UInt32 | Field51; |
| UInt26 | *Field52; |
| UInt32 | Field53; |

};
struct PROT_NAME {

| | |
|---|---|
| UInt32 | Field1; |
| UInt24 | *Field2; |
| UInt32 | Field3; |
| UInt16 | Field4; |
| struct | Field5_SUBFIELD *Field5; |
| UInt32 | Field6; |

};

This example does not have the obfuscation of step 18. Such obfuscation would include techniques such as splitting one data field into several different fields, each containing part of the data of the original field, or scrambling the order of the fields.

All the protocol security protection options are transparent to the developer, who uses the generated data structure as if he was working with a standard (non-obfuscated) protocol. After the protocol definition is pre-processed by the tool, the protocol in source code form has a TLV standard (Type, Length, Value), which allows recursivity and which can be implemented on top of other security techniques (scrambling, encryption, etc.). Recursivity here means that one data structure can host another data structure (such as a tree type data structure.) For example, in the above data Field5 includes 3 subfields and each of those subfields could consist of several sub-subfields.

Within communication protocols expressed as source code, optional information may be encoded as a Type, Length, Value element inside the protocol. The Type and Length fields are fixed in size (typically 1 to 4 bytes which is 8 to 32 bits), and the Value field is of variable size. TLV is used here to “flatten” a complex data structure and is as follows:

Type: A binary code, often simply alphanumeric, which indicates the kind of field that this part of the message represents.

Length: The size of the value field (typically in bytes).

Value: Variable-sized series of bytes which contains data for this part of the message.

Data fields added due to protocol version updates are appended at the end of the previous version's data structure, in order to be version backwards compatible. Thus as described above, protocol Version 1.0 may implement more data fields than Version 0.9, and these added fields are appended at the end of the “payload” of Version 1.0, which means that Version 1.2 and Version 1.0 are compatible.

The security options (see SEC_OPTIONS in the above protocol definition) are, e.g. with appropriate names:

| | |
|---|---|
| SEC_TIMESTAMP | (timestamp) |
| SEC_VARIABLELEN | (variable length) |
| SEC_ENCRYPT | (encryption) |
| SEC_SCRAMBLE | (scrambling) |
| SEC_FAKEFIELDS | (fake fields) |
| SEC_CHECKSUM | checksum or hash) |

Data extractors in the parser are helper functions expressed in computer code which are used to extract data from the fields of an incoming data packet, or to embed a data field in an outgoing data packet. These extractors for example (to respectively extract field data and add a field for a new version) are (in the C programming language):

PROTOCOL_GET_FIELD(char *PROT_NAME, char *SEED,
char *VERSION, boot *isRecursive);
PROTOCOL_ADD_FIELD(char *PROT_NAME, char *SEED,
char *VERSION, boot *isRecursive, Ulnt64 LEN, Ulnt8 * VALUE);

These examples show that the developer may use conventional computer code macros to work with any data input or output of the protocol, in order to insert or extract elements from the protocol payload (field data) shared between two (or more) communicating entities. (A macro in computer science is a set of computer code instructions that is represented in an abbreviated form.) The tool manages these macros and replaces the macros with appropriate “machine code” (object code) in the final binary (compiled) code. The macros are created here by the tool, after the source code version of the protocol is created. The macros are then used by the developer to access data of the protocol. According to the protocol seed, these macros are changed internally, which is done transparently to the developer.

Also, any security options required by a developer can be performed by suitably modifying the tool in order to ultimately generate stronger (more secure against reverse engineering) binary code.

Hardening against reverse engineering and adding complexity to protocol execution as done here is advantageous for global data security. Given a protocol definition to be implemented in a software product, this method automatically provides one or several (at the same or at different times) possible source code implementations of the protocol. The protocol creation process is realized using the software tool. The original protocol definition is expressed in an abstract way and the tool creates a source code implementation of the various elements involved in the protocol. The tool may provide multiple source code implementations of the same protocol definition and also manages protocol legacy versions as explained above, if required. The multiple implementations may vary in terms of the extractors, but are the same in terms of data structure formats. This results in an easy way to improve implementation of a protocol, which is also hardened in terms of reverse engineering.

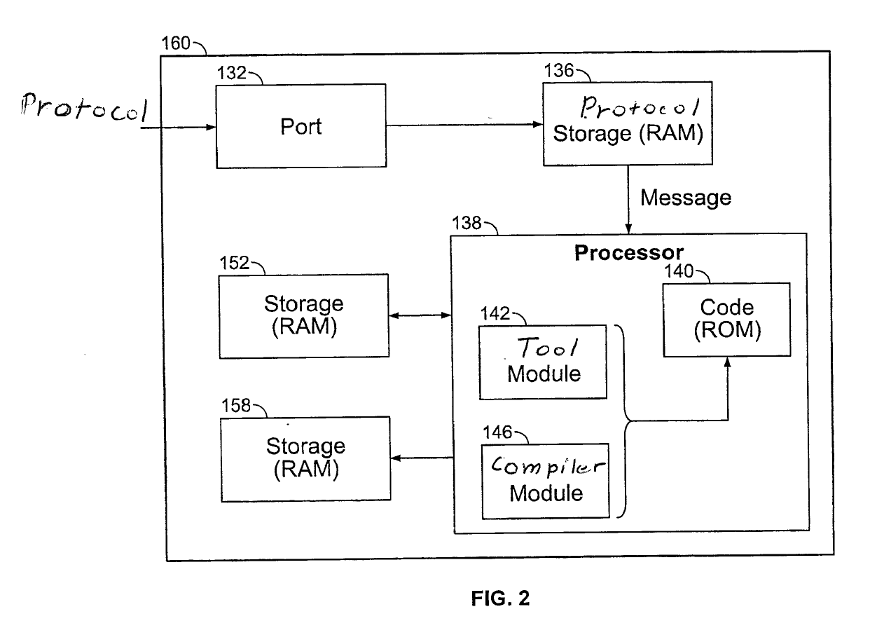

FIG. 2 shows in a block diagram relevant portions of a computing device (system) 160 in accordance with the invention which carries out the protocol creation processes as described above. This is, e.g., a server platform, computer, mobile telephone, Smart Phone, personal digital assistant or similar device, or part of such a device and includes conventional hardware components executing in one embodiment software (computer code) which carries out the above examples. This code may be, e.g., in the C or C++ computer language or its functionality may be expressed in the form of firmware or hardware logic; writing such code or designing such logic would be routine in light of the above examples and logical expressions. Of course, the above examples are not limiting. Only relevant portions of this apparatus are shown for simplicity. Essentially a similar apparatus encrypts the message, and may indeed be part of the same platform.

The computer code embodying the protocol creation tool is conventionally stored in code memory (computer readable storage medium) 140 (as object code or source code) associated with conventional processor 138 for execution by processor 138. The high level protocol definition (in digital form) is received at port 132 and stored in computer readable storage (memory) 136 where it is coupled to processor 138. Processor 138 conventionally then provides the interfaces and obfuscation of steps 16 and 18 at module 142 which embodies the tool. Another software (code) module in processor 138 is the conventional compiler module 146 which carries out the compilation function of step 18 as set forth above, with its associated computer readable storage (memory) 152.

Also coupled to processor 138 is a computer readable storage (memory) 158 for the resulting compiled protocol code. Storage locations 136, 140, 152, 158 may be in one or several conventional physical memory devices (such as semiconductor RAM or its variants or a hard disk drive). Electric signals conventionally are carried between the various elements of FIG. 2. Not shown in FIG. 2 is any subsequent conventional use of the resulting protocol stored in storage 145.

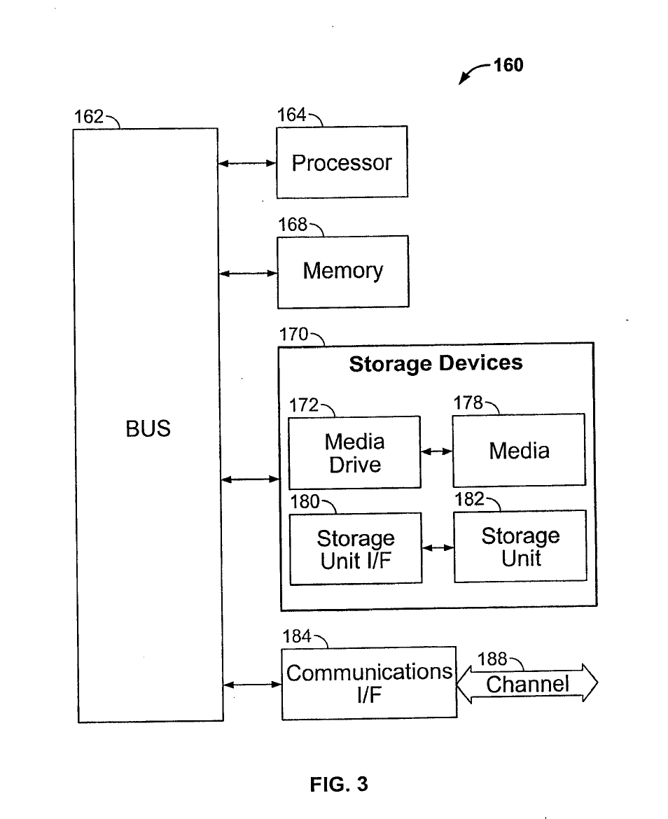

FIG. 3 illustrates detail of a typical and conventional embodiment of computing system 160 that may be employed to implement processing functionality in embodiments of the invention as indicated in FIG. 2 and includes corresponding elements. Computing systems of this type may be used in a computer server or user (client) computer or other computing device, for example. Those skilled in the relevant art will also recognize how to implement embodiments of the invention using other computer systems or architectures. Computing system 160 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 160 can include one or more processors, such as a processor 164 (equivalent to processor 138 in FIG. 2). Processor 164 can be implemented using a general or special purpose processing engine such as, for example, a microprocessor, microcontroller or other control logic. In this example, processor 164 is connected to a bus 162 or other communications medium.

Computing system 160 can also include a main memory 168 (equivalent of memories 136, 140, 152, and 158), such as random access memory (RAM) or other dynamic memory, for storing information and instructions to be executed by processor 164. Main memory 168 also may be used for storing temporary variables or other intermediate information during execution of instructions to be executed by processor 164. Computing system 160 may likewise include a read only memory (ROM) or other static storage device coupled to bus 162 for storing static information and instructions for processor 164.

Computing system 160 may also include information storage system 170, which may include, for example, a media drive 162 and a removable storage interface 180. The media drive 172 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 178 may include, for example, a hard disk, floppy disk, magnetic tape, optical disk, CD or DVD, or other fixed or removable medium that is read by and written to by media drive 72. As these examples illustrate, the storage media 178 may include a computer-readable storage medium having stored therein particular computer software or data.

In alternative embodiments, information storage system 170 may include other similar components for allowing computer programs or other instructions or data to be loaded into computing system 160. Such components may include, for example, a removable storage unit 182 and an interface 180, such as a program cartridge and cartridge interface, a removable memory (for example, a flash memory or other removable memory module) and memory slot, and other removable storage units 182 and interfaces 180 that allow software and data to be transferred from the removable storage unit 178 to computing system 160.

Computing system 160 can also include a communications interface 184 (equivalent to part 132 in FIG. 2). Communications interface 184 can be used to allow software and data to be transferred between computing system 160 and external devices. Examples of communications interface 184 can include a modem, a network interface (such as an Ethernet or other network interface card (NIC)), a communications port (such as for example, a USB port), a PCMCIA slot and card, etc. Software and data transferred via communications interface 184 are in the form of signals which can be electronic, electromagnetic, optical or other signals capable of being received by communications interface 184. These signals are provided to communications interface 184 via a channel 188. This channel 188 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 168, storage device 178, or storage unit 182. These and other forms of computer-readable media may store one or more instructions for use by processor 164, to cause the processor to perform specified operations. Such instructions, generally referred to as “computer program code” (which may be grouped in the form of computer programs or other groupings), when executed, enable the computing system 160 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 160 using, for example, removable storage drive 174, drive 172 or communications interface 184. The control logic (in this example, software instructions or computer program code), when executed by the processor 164, causes the processor 164 to perform the functions of embodiments of the invention as described herein.

This disclosure is illustrative and not limiting. Further modifications will be apparent to these skilled in the art in light of this disclosure and are intended to fall within the scope of the appended claims.

1. A method of obfuscating a computer protocol including at least one data structure, comprising the acts of:
receiving a definition of the protocol at a port;
storing the received definition in a first computer readable storage coupled to the port;
at a processor coupled to the first computer readable storage, converting the definition to a computer source code file which includes the data structure;
obfuscating the source code file; and
storing the obfuscated source code file in a second computer readable storage.

2. The method of claim 1, further comprising compiling the source code file into object code.

3. The method of claim 1, wherein the obfuscating includes at least one of:
partitioning a predetermined data field of the data structure into two or more data fields; and
scrambling an order of data fields of the data structure.

4. The method of claim 1, wherein the definition includes for the protocol a name, a seed value, a version identifier; data fields of the data structure, and a security indicator.

5. The method of claim 4, wherein the security indicator designates at least one of:
a timestamp, a variable length, encryption, scrambling, fake fields, or a checksum or hash.

6. The method of claim 1, wherein the converting includes:
converting the data structure in the definition to computer instructions;
serializing any complexity in the data structure;
parsing the serialized data structure to extract there from the data; and
storing the extracted data in a third computer readable storage.

7. The method of claim 6, wherein the parsing is performed by an extractor function.

8. The method of claim 1, wherein a subsequent version of the protocol is provided, and further comprising the acts of:
determining if the subsequent version of the protocol in its data structure includes an additional data field not present in the first version; and
providing the additional data field in a source code file for the subsequent version, wherein the additional data field is appended to the data fields also present in the first version.

9. The method of claim 8, wherein the two source code files are compatible.

10. The method of claim 1, wherein the source code file includes a type, length, and value format.

11. A computing apparatus programmed to carry out the method of claim 1.

12. A non-volatile computer readable memory carrying instructions to carry out the method of claim 1.

13. Apparatus for obfuscating a computer protocol including at least one data structure, comprising:
a port adapted to receive a definition of the protocol;
a first computer readable storage coupled to the port and adapted to store the received definition;
a processor coupled to the first computer readable storage, and which converts the definition to a computer source code file which includes the data structure;
wherein the processor obfuscates the source code file; and
a second computer readable storage adapted to store the obfuscated source code file.

14. The apparatus of claim 13, further wherein the processor compiles the source code file into object code.

15. The apparatus of claim 13, wherein the obfuscating includes at least one of:
partitioning a predetermined data field of the data structure into two or more data fields; and
scrambling an order of data fields of the data structure.

16. The apparatus of claim 13, wherein the definition includes for the protocol a name, a seed value, a version identifier; data fields of the data structure, and a security indicator.

17. The apparatus of claim 16, wherein the security indicator designates at least one of:
a timestamp, a variable length, encryption, scrambling, fake fields, or a checksum or hash.

18. The apparatus of claim 13, wherein the converting includes:
converting the data structure in the file to computer instructions;
serializing any complexity in the data structure;
parsing the serialized data structure to extract there from the data; and
storing the extracted data in a third computer readable storage.

19. The apparatus of claim 18, wherein the parsing is performed by an extractor function.

20. The apparatus of claim 13, wherein a subsequent version of the protocol is provided, and further comprising the processor:
determining if the subsequent version of the protocol in its data structure includes an additional data field not present in the first version; and
providing the additional data field in a source code file for the subsequent version, wherein the additional data field is appended to the data fields also present in the first version.

21. The apparatus of claim 20, wherein the two source code files are compatible.

22. The apparatus of claim 13, wherein the source code file includes a type, length, and value format.
